(19) United States
(12) Patent Application Publication
(10) Pub. No.: US 2001/0052031 A1
(43) Pub. Date: Dec. 13, 2001

(54) Uniform application programming interface for messaging middleware

(75) Inventor: Ian Kinkade, Madison, CT (US)

Correspondence Address: PERMAN & GREEN, 425 POST ROAD, FAIRFIELD, CT, 06430, US

(73) Assignee: Information Design Inc., Madison, CT (US)

(21) Appl. No.: 09/760,536

(22) Filed: Jan. 16, 2001

Related U.S. Application Data
(60) Provisional application No. 60/176,337, filed on Jan. 14, 2000.

(51) Int. Cl. G06F 9/46; G06F 9/00

(52) U.S. Cl. 709/314; 709/328

(57) ABSTRACT

A method for providing a standard interface between a application programming interface (API) and a message queuing middleware (MQM). The method comprises the steps of receiving a function call. The function call is applied to a message middleware library comprising at least three unique sets of messaging middleware protocols. The method continues to translate the function call to a receiver format associated with one of the messaging middleware protocols and transmits the translated function call to a messaging middleware systems.

### CROSS-REFERENCE TO A RELATED APPLICATION

Priority is herewith claimed under 35 U.S.C. §119(e) from copending Provisional patent application No. 60/176,337, filed Jan. 14, 2000 entitled “Uniform Application Programming Interface for Messaging Middleware”, by Ian Kinkade. The disclosure of this Provisional Patent Application is incorporated by reference herein in its entirety.

### BACKGROUND

Corporate mergers and acquisitions occur frequently in today's marketplace, especially in competitive marketplaces such as the banking and telecommunications industries. Frequently when the companies are combined the need arises to share each other's resources, and information such as computer data. Yet many, if not most, of the computer systems were not designed to inter-operate with other systems. In other words, the information in one company's current applications and/or archived data from a legacy application may not be, and usually isn't, compatible with the other company's application. Thus, such mergers and acquisitions create a new problem in the integration of incompatible computer resources.

In general, the problem of application integration between different applications has been addressed by message queuing middleware service (MQMS). MQMS are a category of software products that provide store-and-forward message delivery, generally to a message queue. In this manner, a first MQMS translates data from one application, sends the data in the form of a message to a message queue, a second MQMS retrieves the message from the message queue, translates the data for use by a second application, and passes the data to the second application. In order for this activity to occur there must be some modification of both the transmitting application and the receiving application for the applications to interface with the MQMSs. Thus, the implementation of these products can be, and usually is expensive. However, the alternative of scrapping the current systems and creating new ones is usually far more expensive. Consequently, the companies utilizing these products are not apt to readily change their underlying technology to accommodate system integration. Yet system integration is critical to the existence of many corporations and organizations. Consider, for example, the complex military organizations and the underlying defense industry. System integration of leading technologies and legacy systems are often critical to the military to perform its mission; as well as to the defense contractor in order to be competitive in today's market place. The military and defense industries depend on MQMs to convey messages containing such data as radar, instrumentation, and confidential output of messages from one application to another, from legacy applications to leading technology applications.

Typically, there are three classes of applications that use underlying Message Queuing Middleware Service (MQMS) products. Included in this group are those found in workflow management, data distribution and enterprise communications. Workflow management involves the monitoring and control of a unit of work as it progresses through a manufacturing or development process. Data distribution involves either the finding or sending of data between front-end clients and/or back-end databases. While enterprise communications involve the sharing and/or dissemination of information within an organization.

Within the context of computer networks and software programs, messaging is defined as the deliberate transmission of data between two or more cooperating programs, which are part of a distributed system. In addition to the data contained within the message, there are parameters listed in the form of arguments that specify the programmatic behavior or properties of the message. For example, parameters such as the priority level of the message, the delivery mode (guaranteed or not), the message expiration time (duration of time that an undelivered message will be destroyed), reply-to-queue (whether the reply message should be sent to the senders queue or to some other queue), e.t.c., are examples of the programmatic data contained within the message's argument list. Ultimately, all the information required about the messages' address, method of delivery, return address of the sender, the message itself, plus any optional return certification will be specified in the message's argument list.

A message is sent to or received from a message queue by an application. Each application has one primary queue, which serves not only as the principal queue upon which it receives messages, but also as its attachment to a queuing engine. It may also have one or more secondary queues up to the limit imposed by the message transport.

Each queue can be named or unnamed. The distinction between the two is that, named queues are known throughout the enterprise and applications receiving messages from these queues know where to send a return message or, alternatively, may use the return address contained within the header of the message. An application that receives a message from an unnamed queue, can only reply to the sender using the queue address stored in the header of that message. Messages are sent in an envelope, i.e., a block of data, carrying information about the endian form of the sending machine, the reply address, the message size, priority and delivery mode.

Transmitted messages can have one or two priorities, normal or high. They can specify delivery modes (whether delivery is guaranteed or not and when the message will be deleted if it is undelivered). At the receiver side, a receiver may call for certain messages by applying receiver selection criteria to the received messages, e.g., high priority messages. The receiver may also issue a time out value to indicate whether the call is a poll (checking for existing messages) or a blocking read (waiting for a specific period of time). Messages are normally read from a queue destructively, but they may be subject to implicit or explicit acceptance. Messages that are implicitly accepted are removed from the queue by a subsequent read operation. Explicitly accepted ones require an explicit statement of acceptance by the application before they can be removed from the queue. When a user application is created using a specific vendor's MQM product, the application must make calls to the vendors MQMS API in order to send or receive messages. Each MQMS API imposes specific programmatic behavior that must be written into the user application in order to utilize the MQMS API. In most cases, this imposes added and certainly undesirable, time and cost to implement a particular vendors product. As examples, return status values that are unique to one MQMS vendor or additional API calls that may be required by another vendor's MQMS product must be coded into the user application in order to receive and transmit messages.

There are currently several vendors supplying MQMS. For example, IBM provides MQSeries, Microsoft provides Microsoft Message Queuing (MSMQ), and BEA Systems Inc. has BEA MessageQ, to name but a few. Moreover, while there are at least two Message-Oriented Middleware Associations, ostensibly to reduce the confusion among the MQMS products, there are currently no standards agreements to facilitate full interoperability between the different MQMS and the world wide web.

### SUMMARY OF THE INVENTION

In accordance with one embodiment of the invention, a method for providing a standard interface between a application programming interface (API) and a message queuing middleware (MQM) is provided. The method comprises the steps of receiving a function call. The function call is applied to a message middleware library comprising at least three unique sets of messaging middleware protocols. The method continues to translate the function call to a receiver format associated with one of the messaging middleware protocols and transmits the translated function call to a messaging middleware systems.

Another embodiment of the invention is directed to an a memory for storing data for access by an application program being executed on a data processing system. The data held in memory comprises a data structure having a function library; wherein the function library comprises at least three unique messaging middleware protocol sets.

In accordance with another embodiment, the invention includes a method for providing a standard data messaging interface between a first application programming interface (API) and a first messaging queuing middleware system. The method comprises the steps of receiving a data message from the first API, wherein the first data message represents a function call by the API. The first data message is translated to at least one message queuing middleware (MQM) format. The step of translating the first data message further comprises the steps of selecting at least one messaging middleware protocol from a protocol library and translating the first data message to conform to the selected messaging middleware protocol. Once translated the first data message is executed.

The invention is also directed to a computer readable medium embodying program code for enabling communicating data from a first application programming interface (API). The method comprises the steps of receiving at least one function call from the first API and applying the at least one function call to a message middleware library. The at least one function call is translated to at least one receiver format. The step of translating the at least one function call further comprises the step of translating the at least one function call to at least one messaging middleware protocol selected from a group of messaging middleware formats. The next step executes the at least one translated function call by transmitting the at least one translated function call to at least one message queuing middleware system. The next step receives from the message queuing middleware system a status message associated with the at least one translated function call and transmits the status message to the originating API.

### BRIEF DESCRIPTION OF THE DRAWINGS

The foregoing aspects and other features of the present invention are explained in the following description, taken in connection with the accompanying drawings, wherein:

FIG. 1 is a block diagram of an embodiment of the invention showing at least one computer and at least one message queuing middleware systems indicating data movement from an application to or from a physical network;

FIG. 2a is a method flow chart of one embodiment of the invention showing the steps for translating data from an application to a message queuing middleware system format;

FIG. 2b is a method flow chart of one embodiment of the invention showing the steps for translating data from a message queuing middleware system to an application format; and

FIG. 3 is a method flow chart of a translating function call within the invention.

### DETAILED DESCRIPTION OF THE PREFERRED EMBODIMENT

Although the present invention will be described with reference to the single embodiment shown in the drawings, it should be understood that the present invention can be embodied in many alternate forms of embodiments.

When a client/server application sends or receives messages, it executes a function call to the MQMS product's Runtime Library (RTL). These function calls are routines commonly known as Application Programming Interface(s) or API(s). The function calls serve as the instruction set for: directing messages, and providing guidelines, methods and controls for the passing or the pulling of messages through their respective client/server application environment to their ultimate destination. As noted above, MQMS are not universal, i.e., not standard, and require changes to the underlying client/server API code.

One embodiment of the invention, the universal translator, provides a single Uniform Message Queuing Interface (UMQI) to multiple or variable Message Queuing Middleware Services (MQMS). The universal translator removes the need for coding the API for specific programmatic behavior of each MQMS and reduces the confusion associated with the range of arguments when multiple MQMS API's are used within an integrated system or complex architecture. Further, by selecting a vendor interface from within the universal translator, the universal translator enables a user to switch from one vendor MQMS to another without having to re-write the application. In this manner, the universal translator provides a virtual message queuing middleware standard.

One form of the universal translator is implemented as IQMessenger™ available from: Information Design, Inc., 145 Durham Road, Suite 11, Madison, Conn. 06443.

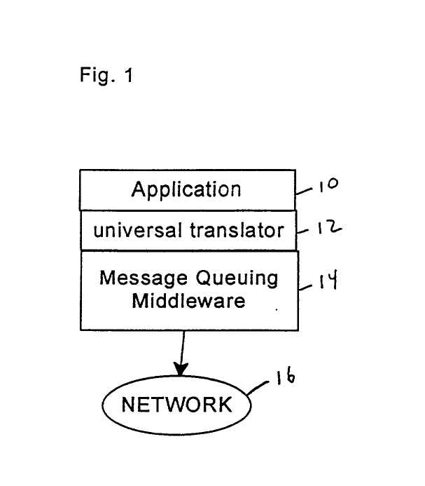

Referring now to FIG. 1, the universal translator 12 functions as a library that implements a Uniform Message Queuing Interface (UMQI) to provide an application 10 with a consistent and single programmatic behavioral Application Programming Interface (API). The functions contained in the library are organized as objects that encapsulate the MQMS vendor API into a single UMQI. The translator is programmed to select the appropriate object based upon predetermined parameters. For example, the translator receives Vendor A's function calls and then maps it to the appropriate object within its UMQI library of functions. The UMQI then translates the data into the most common denominator for the implementation, making available the best capabilities from different MQMS vendors. The translator is programmed to select the appropriate object, or objects, from a plurality of objects corresponding to at least three different MQMS vendors based upon predetermined parameters. For example, in one embodiment of the universal translator, IQMessenger's™ message queuing model, abstracted from an underlying message transport, connects the API to various underlying Message Queuing Middleware (MQM) products by varying the iqvendor (support class) from iqDmQ (BEA MessageQ) to iqMQS (IBM MQSeries) or iqMSMQ (Microsoft MessageQ).

Referring now to FIG. 1, there is shown a block diagram showing the logical relationship of the universal translator 12 to an API 10, MQM 14, and a network 16.

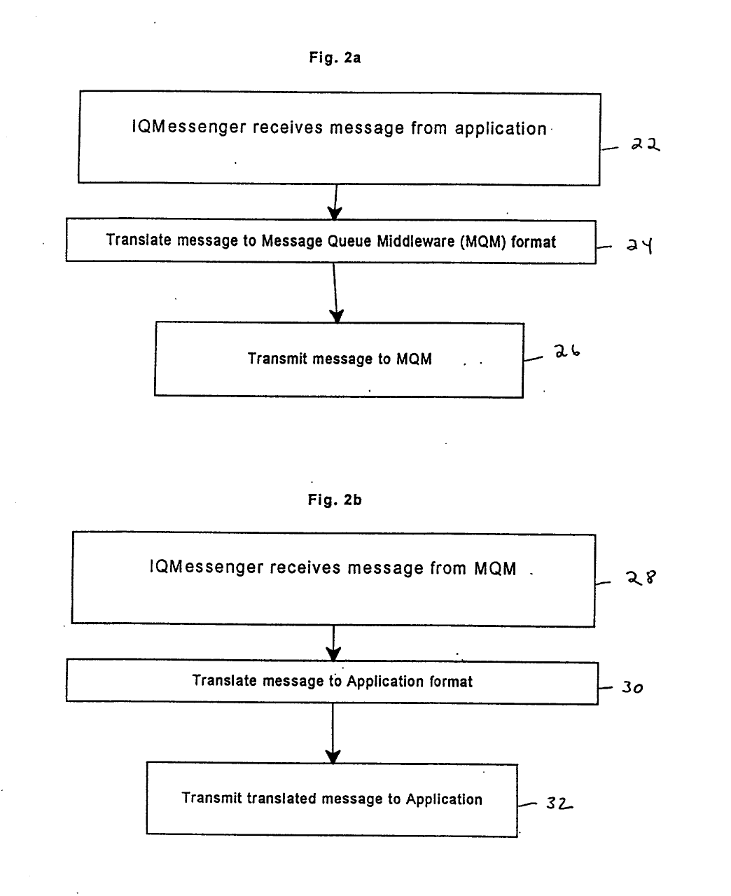

Referring now to FIG. 2a, the universal translator receives 22 a message from an application. The universal translator translates 24 the application message to a selectable or variable message queuing middleware (MQM) format. The translated MQM is then transmitted 26 to the appropriate MQM responsible for transmitting the data to a network.

Referring now to FIG. 2b the universal translator receives 28 a message from an MQM. Universal translator translates 30 the MQM message to a suitable API format. The translated API message is then transmitted 32 to the appropriate API.

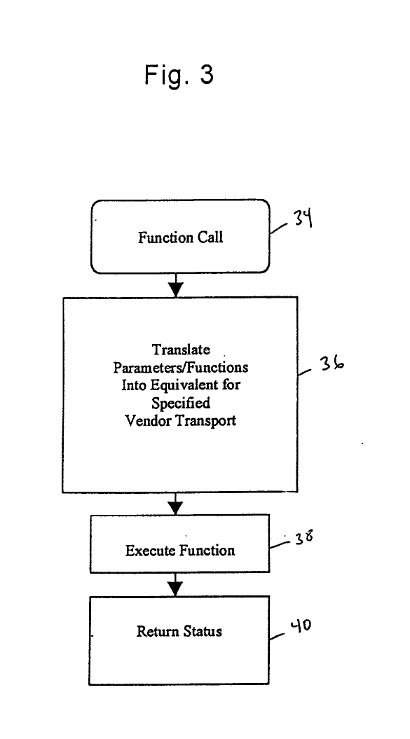

Referring now to FIG. 3, the user application makes a function call 34 to the universal translator UMQI Library. The library serves as the repository for all of the data that is required to perform the translation, including any protocol that must be observed and any data formats required. The library of functions translates 36 the call into a single call or series of MQMS API calls. The MQMS product will then execute 38 these calls and provide the status on each call to the UMQI. The UMQI consolidates the MQMS statuses and translates them into a single UMQI status, which is returned 40 to the user application. In this manner, the application can be written with only one expected programmatic behavior, i.e., that of the universal translator.

Another example of transmitting the data message may be over an internet. In this regard this patent application is also related to U.S. Provisional patent application No. 60/176,218, filed Jan. 14, 2000 entitled “An Efficient Web Based Proxy Message Method and Apparatus for Message Queuing Middleware Resident On a Server Computer”, by Ian Kinkade and patent application Attorney Docket No. 735-009143-US(PAR) for the invention entitled “An Efficient Web Based Proxy Message Method and Apparatus for Message Queuing Middleware Resident On a Server Computer”, filed herewith. The entire contents of said Provisional patent application and said patent application are herein incorporated by reference.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for providing a standard interface between a application programming interface (API) and a message queuing middleware (MQM), the method comprising the steps of:
receiving at least one function call, wherein the step of receiving the at least one function call further comprises the step of:
applying the at least one function call to a message middleware library, wherein the message middleware library comprises at least three unique sets of messaging middleware protocols;
translating the at least one function call to at least one receiver format; and
executing the at least one translated function call.

2. A method as in claim 1 wherein the step of applying the at least one function call to a message middleware library further comprises the step of applying the at least one function call to a C programmed library.

3. A method as in claim 1 wherein the step of translating the at least one function call to the at least one receiver format further comprises the step of translating the at least one function call to at least one messaging middleware protocol selected from the group consisting of a first messaging middleware protocol, a second messaging middleware protocol, and a third messaging middleware protocol.

4. A method as in claim 1 wherein the step of executing the at least one translated function call further comprises the steps of:
transmitting the at least one translated function call to at least one message queuing middleware system;
receiving from the message queuing middleware system a status message associated with the at least one translated function call; and
transmitting the status message to the API.

5. A method as in claim 4 wherein the step of transmitting the at least one translated function call to the at least one message queuing middleware system further comprises the step of transporting the at least one translated function call to a thin client.

6. A method as in claim 4 wherein the step of transmitting the at least one translated function call to the at least one message queuing middleware system further comprises the step of transporting the at least one translated function call to a fat client.

7. A memory for storing data for access by an application program being executed on a data processing system, said memory comprising a data structure stored in said memory, wherein said data structure comprises a function library, wherein the function library comprises at least three unique messaging middleware protocol sets.

8. A memory as in claim 7 wherein said function library further comprises thin client connectivity.

9. A memory as in claim 7 wherein said function library further comprises fat client connectivity.

10. At least one program storage device readable by a machine, tangibly embodying a program of instructions executable by the machine to perform method steps for communicating data from a first application programming interface (API), the method comprising the steps of:
receiving at least one function call from the first API, wherein the step of receiving the at least one function call further comprises the step of applying the at least one function call to a message middleware library;
translating the at least one function call to at least one receiver format, wherein the step of translating the at least one function call to the at least one receiver format further comprises the step of translating the at least one function call to at least one messaging middleware protocol selected from a group consisting of at least three messaging middleware protocol sets; and
executing the at least one translated function call , wherein the step of executing the at least one translated function call further comprises the steps of:
transmitting the at least one translated function call to at least on e message queuing middleware system;
receiving from the message queuing middleware system a status message associated with the at least one translated function call; and
transmitting the status message to the API.

11. A method for providing a standard data messaging interface between a first application programming interface (API) and a first messaging queuing middleware system, the method comprising the steps of:
receiving a first data message from the first API, wherein the step of receiving the first data message further comprises the step of receiving a first function call;
translating the first data message to at least one message queuing middleware (MQM) format; wherein the step of translating the first data message further comprises the steps of
selecting at least one messaging middleware protocol from a protocol library, wherein the protocol library comprises at least three unique sets of messaging middleware protocols;
translating the first data message to conform to the selected messaging middleware protocol; and
executing the translated first data message.

12. A method as in claim 11 wherein the step of executing the at least one translated first data message further comprises the steps of:
transmitting the translated first data message to the first message queuing middleware system;
receiving from the first message queuing middleware system a status message associated with the translated first data message; and
transmitting the status message to the first API.

13. A method as in claim 12 wherein the step of transmitting the at least one translated function call to the at least one message queuing middleware system further comprises the step of transporting the at least one translated function call to a thin client.

14. A method as in claim 12 wherein the step of transmitting the at least one translated function call to the at least one message queuing middleware system further comprises the step of transporting the at least one translated function call to a fat client.
